(19) United States
(12) Patent Application Publication
(10) Pub. No.: US 2026/0359230 A1
(43) Pub. Date: Nov. 12, 2026

(54) SYSTEM AND METHOD FOR FLEXIBLE PSEUDO-LEAST RECENTLY USED (LRU) CACHE REPLACEMENT PROCESS

(71) Applicant: QUALCOMM Incorporated, San Diego, CA (US)

(72) Inventors: Doron KARNIBAD, Tel Mond (IL); Ron BERCOVICH, Woluwe-Saint-Pierre (BE); Alon RACHMANI, Rehovot (IL); Albert YOSHER, Tel Mond (IL); Ran HAY, Rosh Haaein (IL); Alon GLICK, Tel Aviv (IL)

(21) Appl. No.: 19/201,733

(22) Filed: May 7, 2025

(51) Int. Cl. G06F 12/123

(52) U.S. Cl. CPC G06F 12/123; G06F 2212/1016

(57) ABSTRACT

A method is described. The method includes forming a pseudo-least recently used (LRU) cache replacement tree having a number of way leaves greater than or equal to a number of ways of a cache memory. The method also includes identifying unused ways of the pseudo-LRU cache replacement tree according to a difference between the number of way leaves of the pseudo-LRU cache replacement tree and the number of ways of the cache memory. The method further includes updating status bits of nodes representing the pseudo-LRU cache replacement tree to block access to the identified, unused ways of the cache memory.

### BACKGROUND

### Field

Aspects of the present disclosure relate to memory subsystems and, more particularly, to a system and method for a flexible pseudo-least recently used (LRU) cache replacement process.

### BACKGROUND

Multi-processor computer systems utilize cache memory for improved data access. Cache memory is generally composed of small, high-speed memories that store copies of frequently used data and/or instructions. Multi-processor computer systems may include multiple cache levels (e.g., a level one (L1), a level two (L2) cache, a level three (L3) cache, etc.), which provide multiple levels of a memory hierarchy that also includes a main memory as well as a mass-storage device. Unfortunately, in a two-level cache memory hierarchy, when an attempt to access a cache line misses in the L1 cache (e.g., a cache miss), the L1 cache forwards the request to the L2 cache (which may in turn forward the request to the main memory and possibly to a mass-storage device). Because each level of the memory hierarchy exhibits a gradually increased access time, avoiding unnecessary cache misses can improve computer system performance.

In these multi-processor computer systems, cache replacement policies are used to manage cache allocation. One of the most widely adopted implementations for a cache allocation and replacement process is tree-pseudo least recently used (PLRU). In practice, the tree-PLRU cache allocation and replacement process works well for power of two (2) (e.g., 2^{N}, in which N is an integer greater than 1) in a number of cache ways, a binary search tree utilized by the tree-PLRU cache replacement process is balanced between all branches. Unfortunately, when a memory design specifies a number of cache ways that are not a power of 2, the tree-PLRU cache replacement process is unusable (e.g., due to rigid specifications for area/performance optimizations). Additionally, when some ways are locked for use due to software specifications, the tree-PLRU cache replacement process fails to find a valid way to replace. A flexible pseudo-LRU cache replacement process is desired.

### SUMMARY

A method is described. The method includes forming a pseudo-least recently used (LRU) cache replacement tree having a number of way leaves greater than or equal to a number of ways of a cache memory. The method also includes identifying unused ways of the pseudo-LRU cache replacement tree according to a difference between the number of way leaves of the pseudo-LRU cache replacement tree and the number of ways of the cache memory. The method further includes updating status bits of nodes representing the pseudo-LRU cache replacement tree to block access to the identified, unused ways of the cache memory.

A cache memory system is described. The cache memory system includes a cache memory. The cache memory system also includes a memory controller configured to form a pseudo-least recently used (LRU) cache replacement tree having a number of way leaves greater than or equal to a number of ways of the cache memory, to identify unused ways of the pseudo-LRU cache replacement tree according to a difference between the number of way leaves of the pseudo-LRU cache replacement tree and the number of ways of the cache memory, and to update status bits of nodes representing the pseudo-LRU cache replacement tree to block access to the identified, unused ways of the cache memory.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for a flexible pseudo-least recently used (LRU) cache replacement process, in accordance with various aspects of the present disclosure.

FIG. 2 is a circuit diagram further illustrating the system-on-chip (SoC) of FIG. 1, including a cache memory system configured according to a flexible pseudo-least recently used (LRU) cache replacement process, according to various aspects of the present disclosure.

FIG. 3 is a block diagram further illustrating a flexible pseudo-least recently used (LRU) cache replacement process, according to various aspects of the present disclosure.

FIG. 4 is a block diagram further illustrating a pseudo-least recently used (LRU) tree implementing a flexible pseudo-LRU cache replacement process, according to various aspects of the present disclosure.

FIG. 5 is a block diagram of a truth table for implementing a pseudo-least recently used (LRU) tree implementing the flexible pseudo-LRU cache replacement process of FIG. 4, according to various aspects of the present disclosure.

FIG. 6 is a process flow diagram illustrating a method for a flexible pseudo-least recently used (LRU) cache replacement process, according to various aspects of the present disclosure.

FIG. 7 is a block diagram showing an exemplary wireless communications system in which an aspect of the disclosure may be advantageously employed.

FIG. 8 is a block diagram illustrating a design workstation used for circuit, layout, and logic design of a semiconductor component according to the cache memory of the pseudo-least recently used (LRU) cache replacement process disclosed herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced. Similarly, the terms “chip” and “die” may be used interchangeably.

Multi-processor computer systems utilize cache memory for improved data access. Cache memory is generally composed of small, high-speed memories that store copies of frequently used data and/or instructions. Multi-processor computer systems may include multiple cache levels (e.g., a level one (L1), a level two (L2) cache, a level three (L3) cache, etc.), which provide multiple levels of a memory hierarchy that also includes a main memory as well as a mass-storage device. For example, in a two-level cache memory hierarchy, the multi-processor computer systems first access the L1 cache when attempting to access a given cache line. If the cache line is present in the L1 cache (e.g., a cache hit), the cache access is very fast. Unfortunately, when an attempt to access the cache line misses in the L1 cache (e.g., a cache miss), the L1 cache forwards the request to the L2 cache (which may in turn forward the request to the main memory and possibly to a mass-storage device). Because each level of the memory hierarchy exhibits a gradually increased access time, avoiding unnecessary cache misses can improve computer system performance.

In these multi-processor computer systems, cache replacement policies are used to manage cache allocation. As noted, caching improves performance by keeping recent or often-used data items in memory locations that are faster, or computationally cheaper to access, than normal memory stores. When the cache is full, the cache replacement process selects the items that are discarded to make room for the new data. One of the most widely adopted implementations for a cache allocation and replacement process is tree-pseudo least recently used (PLRU). Tree-PLRU is an efficient process, with a very small hardware cost, to select an item that most likely has not been accessed recently, given a set of items and a sequence of memory access events.

In practice, the tree-PLRU cache replacement process works well for power of two (2) (e.g., 2^{N}, in which N is an integer greater than 1) in a number of cache ways, a binary search tree utilized by the tree-PLRU cache replacement process is balanced between all branches. Unfortunately, when a memory design specifies a number of cache ways that are not a power of 2, the tree-PLRU cache replacement process is unusable (e.g., due to rigid specifications for area/performance optimizations). Additionally, when some ways are locked for use due to software specifications, the tree-PLRU cache replacement process fails to find a valid way to replace. A flexible pseudo-LRU cache replacement process is desired.

Various aspects of the present disclosure are directed to a system and method for a flexible pseudo-LRU cache replacement process. In particular, various aspects of the present disclosure are directed to addressing inefficiencies of the pseudo-least recently used (PLRU) replacement process for cache systems that specify non-power of-2 cache way configurations and the inability to lock cache ways is due to algorithmic specification enforced by hardware. Various aspects of the present disclosure introduce enhancements to the pseudo-LRU cache replacement process, providing flexibility for set-associative cache systems by supporting any number of cache ways and enabling the locking of certain cache ways on demand. This implementation maintains the area cost efficiency of pseudo-LRU while achieving the flexibility of full LRU methods.

In some implementations, a modified tree-PLRU cache replacement process begins with all arrows pointing to the right-hand side in a binary search tree. This implementation offers flexibility by supporting caches with a non-power of 2 number of ways and includes mechanisms to lock certain cache ways, ensuring they are blocked from selecting a replacement unless unlocked. The modified tree-PLRU cache replacement process involves setting status bits that guide the selection and locking of cache ways, allowing systems to achieve similar flexibility to full LRU policies but at a lower area cost. The potential benefits include reduced area costs in cache systems and adaptability to varying cache requirements without the need for costly alternatives, as well as flexibility in cache configurations with non-power of 2 number of ways and locking capabilities.

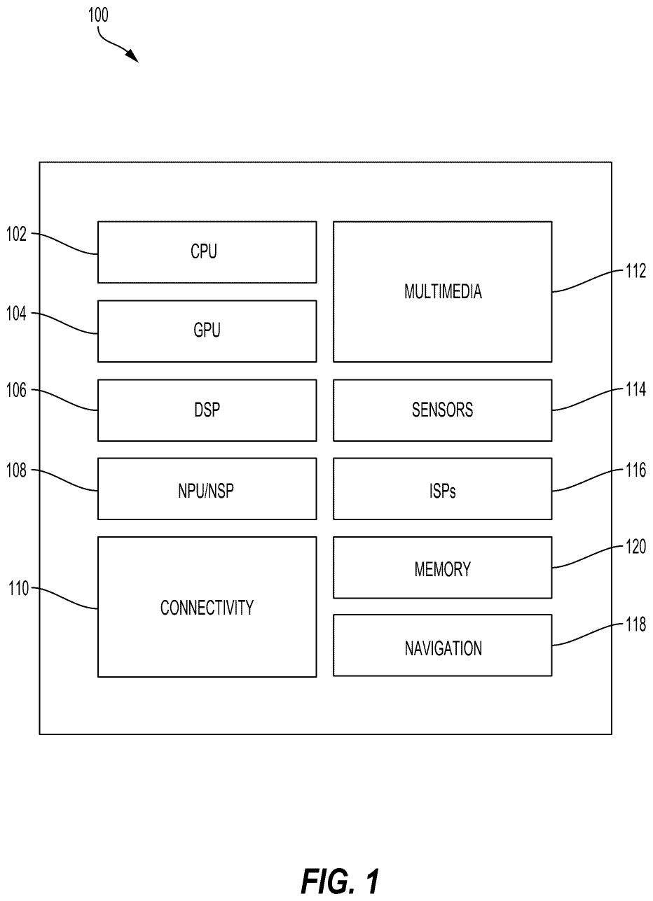

FIG. 1 illustrates an example implementation of a host system-on-chip (SoC) 100, which is configured for a flexible pseudo-least recently used (LRU) cache replacement process, in accordance with various aspects of the present disclosure. The host SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU)/neural signal processor (NSP) 108. The host SoC 100 may also include a sensor processor 114, image signal processors (ISPs) 116, a navigation module 118, which may include a global positioning system, and a memory 120. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, RISC-V, an advanced RISC machine (ARM), a microprocessor, or any reduced instruction set computing (RISC) architecture. The NPU/NSP 108 may be based on an ARM instruction set.

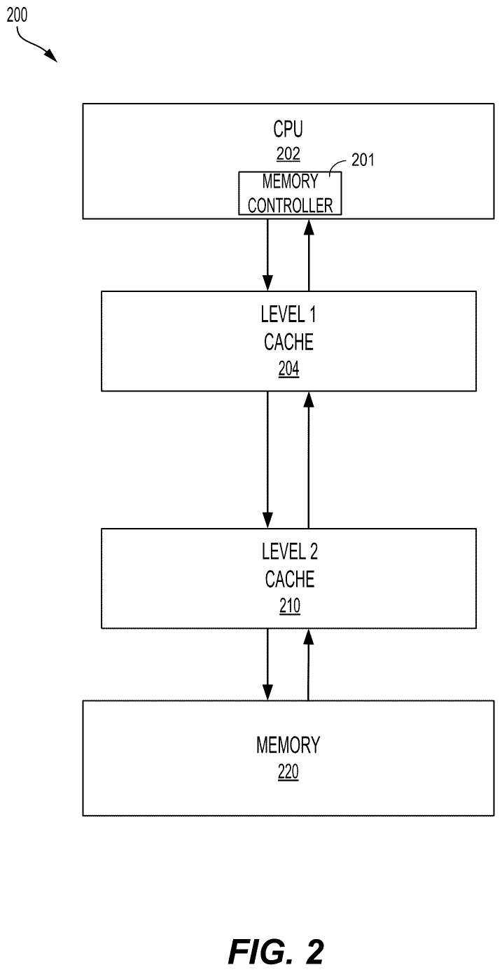

FIG. 2 is a circuit diagram further illustrating the system-on-chip (SoC) 100 of FIG. 1, including a cache memory system configured according to a flexible pseudo-least recently used (LRU) cache replacement process, according to various aspects of the present disclosure. As shown in FIG. 2, a multi-processor computer system 200 utilizes cache memory for improved data access a memory controller 201. Cache memory is generally composed of small, high-speed memories that store copies of frequently used data and/or instructions utilizing the memory controller 201. In this example, the multi-processor computer system 200 includes a level one (L1) cache 204 and a level two (L2) cache 210, which provide two levels of a memory hierarchy that also includes a memory 220 (e.g., DDR memory) as well as a mass-storage device (not shown).

In practice, the multi-processor computer system 200 first accesses the L1 cache 204, which may reside on a CPU 202 when attempting to access a given cache line. If the cache line is present in the L1 cache 204 (e.g., a cache hit), the cache access is expedient. Unfortunately, when an attempt to access the cache line misses in the L1 cache 204 (e.g., a cache miss), the L1 cache 204 forwards the request to the L2 cache 210 (which may in turn forward the request to the memory 220 and then to a mass-storage device). Because each level of the memory hierarchy exhibits a gradually increased access time, avoiding unnecessary cache misses can improve performance of the multi-processor computer system 200.

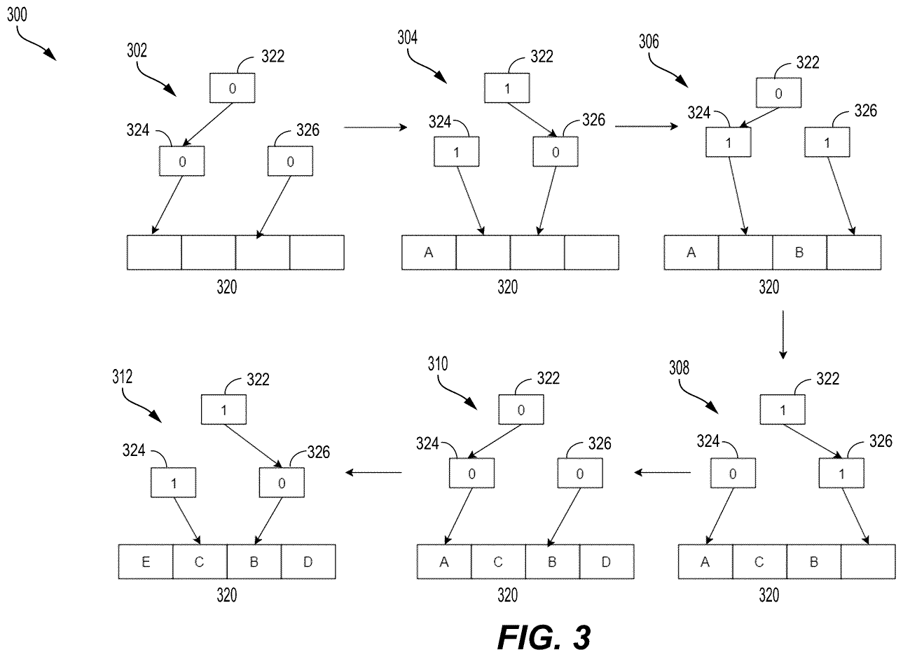

In these multi-processor computer systems, cache replacement policies are used to manage cache allocation. As noted, caching improves performance by keeping recent or often-used data items in memory locations hat are faster, or computationally cheaper to access, than normal memory stores. When the cache is full, the cache replacement process selects the items that are discarded to make room for the new data. One of the most widely adopted implementations for a cache allocation and replacement process is tree-pseudo least recently used (PLRU). Tree-PLRU is an efficient process, with a very small hardware cost to implement in the memory controller 201, to select an item that most likely has not been accessed recently, given a set of items and a sequence of memory access events, for example, as shown in FIG. 3.

FIG. 3 is a block diagram further illustrating a pseudo-least recently used (LRU) cache replacement process 300, according to various aspects of the present disclosure. As shown in FIG. 3, the pseudo-LRU cache replacement process 300 is performed as follows. At step 302, consider a binary search tree 320 for an item that most likely has not been accessed recently, given a set of items and a sequence of memory access events. Each node (e.g., 322, 324, 326) of the binary search tree 320 includes a single bit flag denoting “go in a left direction to insert a pseudo-LRU element” or “go in a right direction to insert a pseudo-LRU element.” To find a pseudo-LRU element, traverse the binary search tree 320 according to the values of the flags. To update the binary search tree 320 with an access to an item N, traverse the binary search tree 320 to find N and, during the traversal, set the node flags to denote the direction that is opposite to the direction taken.

For example, at step 304, an item ‘A’ is stored in the binary search tree 320 based on the initial arrow of nodes 322 and 324. Once stored, the bit flags of nodes 322 and 324 are updated from ‘0’ to ‘1,’ while the status flag of node 326 is unchanged. At step 306, an item ‘B’ is stored in the binary search tree 320 based on the initial arrow of nodes 322 and 326. Once stored, the bit flags of nodes 322 and 326 are updated from ‘1’ to ‘0’ and ‘0’ to ‘1,’ respectively, while the status flag of node 324 is unchanged. At step 308, an item ‘C’ is stored in the binary search tree 320 based on the arrow of nodes 322 and 324 in step 306. Once stored, the bit flag of nodes 322 and 324 are updated from ‘0’ to ‘1’ and ‘1’ to ‘0,’ respectfully, while the status flag of node 326 is unchanged. At step 310, an item ‘D’ is stored in the binary search tree 320 based on the arrow of nodes 322 and 326 in step 308. Once stored, the bit flags of nodes 322 and 326 are updated from ‘1’ to ‘0,’ while the status flag of node 324 is unchanged. At step 312, an item ‘E’ is being stored, however the cache memory is full. In this example, the arrow of node 324 in step 310 points at the pseudo-LRU element ‘A.’ The pseudo-LRU element ‘A’ is evicted, and the item ‘E’ is stored in the binary search tree 320. Once stored, the bit flags of nodes 322 and 324 are updated from ‘0’ to ‘1,’ while the status flag of node 326 is unchanged.

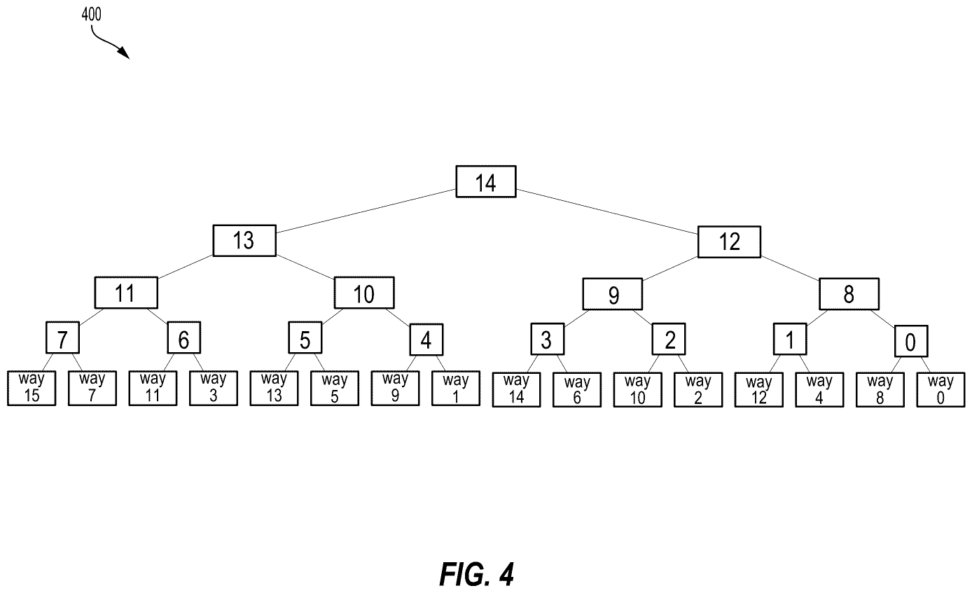

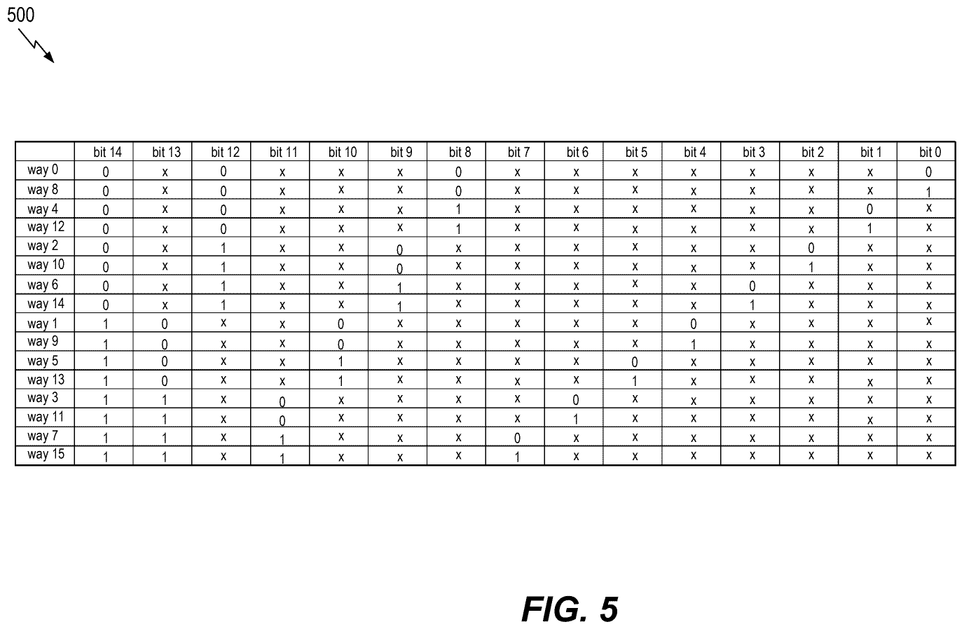

In practice, the pseudo-LRU cache replacement process 300 shown in FIG. 3 works well for cache memory systems configured with a power of two (2) in a number of cache ways. In this configuration, the binary search tree 320 utilized by the pseudo-LRU cache replacement process 300 is balanced between all branches. Unfortunately, when a cache memory design specifies a number of cache ways that are not a power of 2, the pseudo-LRU cache replacement process 300 is unusable (e.g., due to rigid specifications for area/performance optimizations). Additionally, when some ways are locked for use due to software specifications, the pseudo-LRU cache replacement process 300 fails to find a valid way to replace. A flexible pseudo-LRU cache replacement process is shown, for example, in FIGS. 4 and 5.

FIG. 4 is a block diagram further illustrating a pseudo-least recently used (LRU) tree implementing a flexible pseudo-LRU cache replacement process, according to various aspects of the present disclosure. FIG. 5 is a block diagram of a truth table for implementing a pseudo-LRU tree implementing the flexible pseudo-LRU cache replacement process of FIG. 4, according to various aspects of the present disclosure.

Various aspects of the present disclosure are directed to a solution for providing flexibility in expensive cache replacement policies (e.g., full LRU) while maintaining the area cost of the pseudo-LRU cache replacement policy. In some implementations, this flexibility is provided by working with any number of cache ways (e.g., not limited to power of 2 (2^{N}, in which N is an integer greater than 1)) and in allowing the locking of certain ways on demand. Although the description shown in FIGS. 4 and 5 is based on a sixteen (16)-way set-associative cache (e.g., N=4), various aspects of the present disclosure are applicable to any number of cache ways.

As shown in FIG. 4, a pseudo-LRU cache replacement tree 400 (e.g., a binary tree) is configured based on a 16-way set-associative cache. A “fully-associative” cache provides a possible cache storage organization technique to reduce cache misses, in which any entry can store cache lines from any address in the next higher level of memory hierarchy. Unfortunately, fully-associative caches are difficult to implement. Because fully-associative caches are difficult to implement, multi-processor computer systems may use “set-associative” caches. In a set-associative cache, entries are logically divided into two or more “ways.” Each way in turn includes entries that are part of one or more “sets.” Set-associative caches are well-known in the art and hence are not described in more detail.

FIG. 4 illustrates the pseudo-LRU cache replacement tree 400 as having sixteen ways (way 0, way 1, . . . , way 15) corresponding to fifteen nodes (node 0, node 1, . . . , node 14), in which node 14 is a root node, nodes 0 to 7 are last nodes and ways 0, 8, 4, 12, 2, 10, 6, 14, 1, 9, 5, 13, 3, 11, 7, and 15 represent a number of way leaves. As shown in FIG. 4, the pseudo-LRU cache replacement tree 400 starts with all arrows pointing to the right-hand side. In this configuration, allocation of available ways is performed according to the incremental numbering, beginning with way 0, and ending with way 15, shown in FIG. 4 according to the truth table 500, as shown in FIG. 5.

In this example, the truth table 500 is organized such that the rows represent the way leaves (e.g., way 0, . . . , way 15), and the columns represent the nodes (e.g., node 14, node 13, . . . , node 0), corresponding to status bits (e.g., bit 14, . . . , bit 0). In this arrangement, the first column represents a root node 14 (e.g., status bit 14) of the pseudo-LRU cache replacement tree 400. For example, accessing of way 0 begins with checking a bit 14 status bit of the truth table 500. In this example, a ‘0’ value indicates an arrow from a root node 14 points to the right, which leads to status bit 12 of a node 12, which also indicates a ‘0’ value, leading to status bit 8 of node 8. In this example, status bit 8 of node 8 indicates a ‘0’ value, leading to status bit 0 of node 0 (e.g., the status bits of last nodes), which is between node 8 and way 0 as well as way 8. In this example, the status bit 0 of node 8 indicates indicating a ‘0’ value, leading to way 0.

Once allocation of the ways in the pseudo-LRU cache replacement tree 400 is complete, a next selected way (e.g., a pseudo-LRU way) is selected based on the values of the 15 status bits (marked 0 to 14) associated with the various nodes (e.g., node 14, node 13, . . . , node 0), and separate from the truth table 500, in which the values are fixed. During operation, once all ways are in use, the next allocated way is based on the status bits of the nodes beginning with the root node 14. For example, detection of the pseudo-LRU way is based on the current arrow directions, beginning with the root node 14, as indicated by values (e.g., ‘1’—left arrow, ‘0’—right arrow) of the status bits (e.g., bit 14, . . . , bit 0). For example, the first value (e.g., ‘1’—left arrow) may indicate a left branch to a subsequent node or a subsequent way leaf. Similarly, the second value (e.g., ‘0’—right arrow) may indicate a right branch to a subsequent node or a subsequent way leaf.

For example, assuming way 0 is identified as the pseudo-LRU way, a value of way 0 is evicted and a new value is stored in way 0, which is no longer the pseudo-LRU way. For example, once way 0 is accessed by a processor, all arrows in the path from the root node 14 of the pseudo-LRU cache replacement tree 400 to the branch with the way 0 are turned to the direction away from that way. In this example, the arrows are switched and now point to the left, (e.g., from node 0 toward way 8, node 8 toward node 1, node 12 toward node 9, and root node 14 to node 13. Based on this example, assuming the remaining arrows point to the right after node 13, way 1 is now the pseudo-LRU way (e.g., through the arrow pointing right to node 10, the arrow pointing right to node 4, and the arrow pointing right to way 1 (e.g., a way leaf).

This example described above are provided in reference node modification in response to a cache miss. The nodes, however, are affected also when the cache is accessed for a read operation. In the explanations provided above, switching of the arrows to point in an opposite direction occurred in response to a cache miss. In this scenario, a new line is placed in the cache according to tree-PLRU. By contrast, in the case of a cache hit (e.g., data found in the cache), the found line becomes most recently accessed so all arrows pointing to this way are switched, in the same manner as previously explained for new line insertion.

Additionally, locking a way specifies that under all conditions the locked way is not selected. For example, locking of a way is performed as follows. Once locked, the status bit leading to a locked way ignores update requests and keeps pointing to the unlocked side. If both directions of a status bit are locked, its value is irrelevant and the status bit leading to that bit is limited to ignore updates pointing in that direction. When a locked way is released, all status bits on the path to the locked way stop ignoring update requests.

According to various aspects of the present disclosure, the pseudo-LRU cache replacement tree 400 is configured to support a non-power of 2 in a number of cache ways by “locking” in the pseudo-LRU cache replacement tree 400 all ways that are not implemented. For example, implementation of a 13 way design using the pseudo-LRU cache replacement tree 400 having 16 ways is implemented by having ways 13 to 15 constantly locked and unavailable for selection. Additionally, the indexes of the non-existing ways (e.g., ways 13 to 15) are scattered over the pseudo-LRU cache replacement tree 400 in the fairest manner. In this example, identifying unused ways of the pseudo-LRU cache replacement tree 400 occurs according to a difference between the number of cache way leaves of the pseudo-LRU cache replacement tree 400 and the number of cache ways of the cache memory to indicate the unused ways.

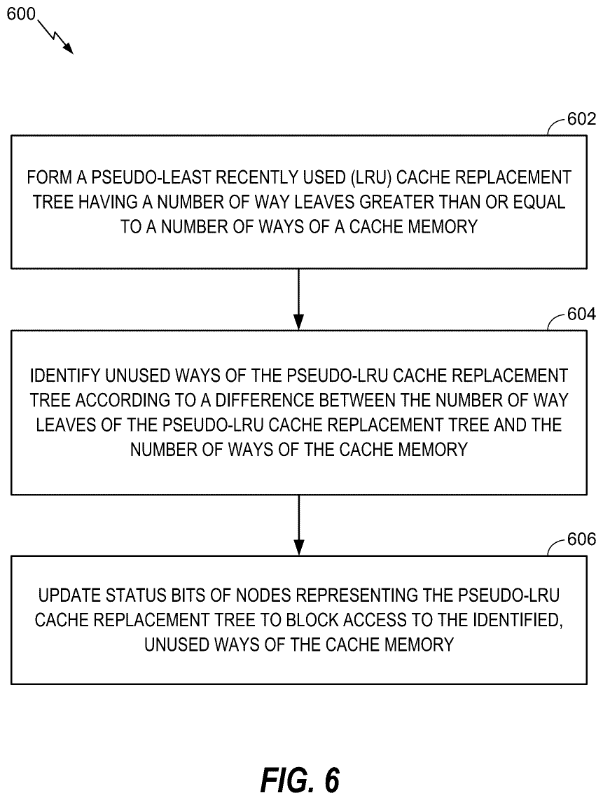

Functionally locking a way in the existing range behaves the same as in a power of 2-sized design. While investing the relatively small area cost of pseudo-LRU hardware, the full flexibility of the number of cache ways and the ability to lock ways is maintained. Maintaining the full flexibility of the number of cache ways and the ability to lock ways reduces the area cost in cache systems that were forced to use expensive cache replacement policies for the ability to lock ways or to have non-power of 2 ways. Additionally, the capability of unlocking one or more ways may enable assigning of unlocked ways to a high-priority processor, while locking the ways to block access from non-priority processors. The ability to use a non-power of 2-sized cache (with non-power of 2 ways) using tree-PLRU replacement with the option to lock ways according to a flexible pseudo-LRU cache replacement process is shown, for example, in FIG. 6.

FIG. 6 is a process flow diagram illustrating a method 600 for cache replacement, according to various aspects of the present disclosure. The method 600 begins at block 602, in which a pseudo-least recently used (LRU) cache replacement tree is formed, having a number of way leaves greater than or equal to a number of ways of a cache memory. For example, the pseudo-LRU cache replacement tree 400 in FIG. 4 is shown as having sixteen ways (way 0, way 1, . . . , way 15) corresponding to fifteen nodes (node 0, node 1, . . . , node 14), in which node 14 is a root node, nodes 0 to 7 are last nodes and ways 0, 8, 4, 12, 2, 10, 6, 14, 1, 9, 5, 13, 3, 11, 7, and 15 represent a number of way leaves. In this configuration, allocation of available ways is performed according to the incremental numbering, beginning with way 0, and ending with way 15, according to the truth table 500, as shown in FIG. 5.

At block 604, unused ways of the pseudo-LRU cache replacement tree are identified according to a difference between the number of way leaves of the pseudo-LRU cache replacement tree and the number of ways of the cache memory. At block 606, status bits of nodes representing the pseudo-LRU cache replacement tree are updated to block access to the identified, unused ways of the cache memory. For example, as shown in FIGS. 4 and 5, the sixteen ways (way 0, way 1, . . . , way 15) that are part of the cache memory can be locked (and then may be considered as non-existing while locked). Additionally, the sixteen way-leaves (way 0, way 1, . . . , way 15) may be exactly the same as the number of cache ways when no way-leaves are locked.

In some aspects, the method 600 may be performed by the SoC 100 (FIG. 1). That is, each of the elements of the method 600 may, for example, but without limitation, be performed by the SoC 100 or one or more processors (e.g., CPU 102 and/or NPU 130) and/or other components included therein.

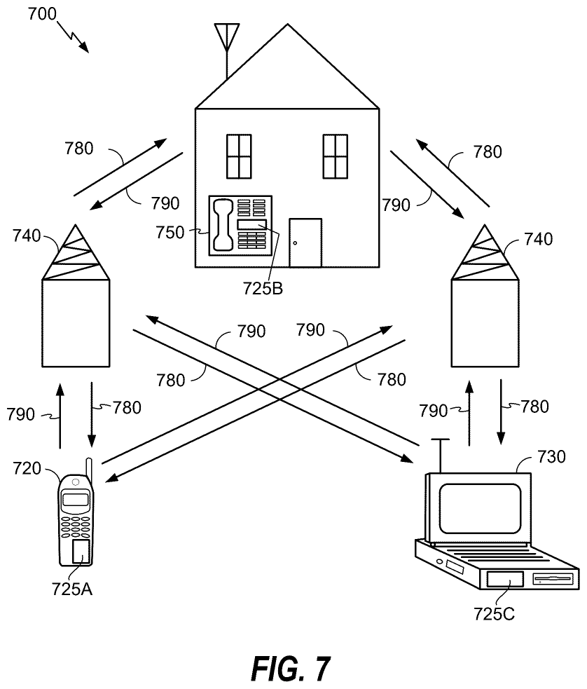

FIG. 7 is a block diagram showing an exemplary wireless communications system 700 in which an aspect of the disclosure may be advantageously employed. For purposes of illustration, FIG. 7 shows three remote units 720, 730, and 750, and two base stations 740. It will be recognized that wireless communications systems may have many more remote units and base stations. Remote units 720, 730, and 750 include IC devices 725A, 725C, and 725B that include the disclosed pseudo-least recently used (LRU) cache replacement process. It will be recognized that other devices may also include the disclosed pseudo-LRU cache replacement process, such as the base stations, switching devices, and network equipment. FIG. 7 shows forward link signals 780 from the base stations 740 to the remote units 720, 730, and 750, and reverse link signals 790 from the remote units 720, 730, and 750 to base stations 740.

In FIG. 7, remote unit 720 is shown as a mobile telephone, remote unit 730 is shown as a portable computer, and remote unit 750 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 7 illustrates remote units according to aspects of the present disclosure, the disclosure is not limited to these exemplary illustrated units. Aspects of the present disclosure may be suitably employed in many devices, which include the disclosed pseudo-LRU cache replacement process.

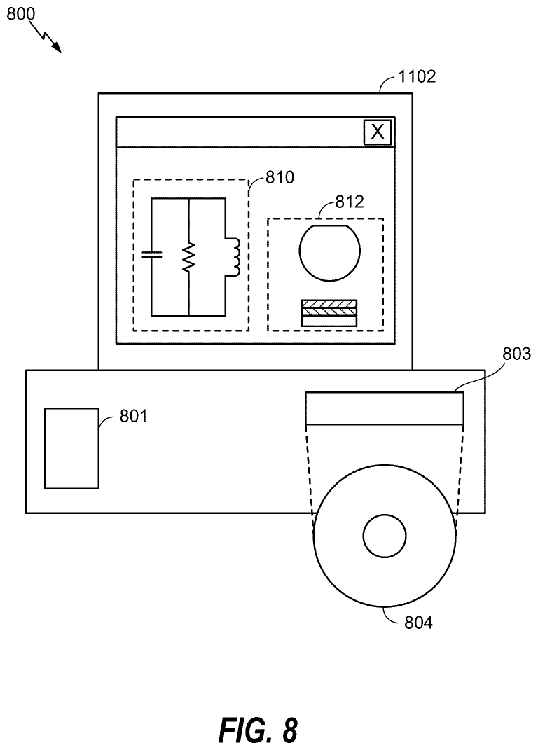

FIG. 8 is a block diagram illustrating a design workstation used for circuit, layout, and logic design of a semiconductor component, such as the cache memory of the pseudo-least recently used (LRU) cache replacement process disclosed above. A design workstation 800 includes a hard disk 801 containing operating system software, support files, and design software such as Cadence or OrCAD. The design workstation 800 also includes a display 802 to facilitate design of a circuit 810 or an integrated circuit (IC) component 812 such as the disclosed the cache memory of the pseudo-LRU cache replacement process. A storage medium 804 is provided for tangibly storing the design of the circuit 810 or the IC component 812 (e.g., the cache memory of the pseudo-LRU cache replacement process). The design of the circuit 810 or the IC component 812 may be stored on the storage medium 804 in a file format such as GDSII or GERBER. The storage medium 804 may be a CD-ROM, DVD, hard disk, flash memory, or other appropriate device. Furthermore, the design workstation 800 includes a drive apparatus 803 for accepting input from or writing output to the storage medium 804.

Data recorded on the storage medium 804 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 804 facilitates the design of the circuit 810 or the IC component 812 by decreasing the number of processes for designing semiconductor wafers.

Implementation examples are described in the following numbered clauses:
1. A method for cache replacement, the method comprising:
forming a pseudo-least recently used (LRU) cache replacement tree having a number of way leaves greater than or equal to a number of ways of a cache memory;
identifying unused ways of the pseudo-LRU cache replacement tree according to a difference between the number of way leaves of the pseudo-LRU cache replacement tree and the number of ways of the cache memory; and
updating status bits of nodes representing the pseudo-LRU cache replacement tree to block access to the identified, unused ways of the cache memory.
2. The method of clause 1, further comprising updating, during reading and writing of the cache memory, the status bits of nodes representing the pseudo-LRU cache replacement tree to enable detection of a pseudo-LRU way.
3. The method of any of clauses 1 or 2, in which updating status bits comprises blocking access to a way leaf representing the unused ways of the cache memory.
4. The method of any of clauses 1-3, further comprising:
locking one or more additional ways of the pseudo-LRU cache replacement tree; and
assigning the one or more additional ways of the pseudo-LRU cache replacement tree to a high-priority processor.
5. The method of any of clauses 1-4, in which the pseudo-LRU cache replacement tree comprises 2^{N} way leaves, in which N is an integer greater than 1.
6. The method of any of clauses 1-5, in which the cache memory comprises a level one (L1) cache.
7. The method of any of clauses 1-5, in which the cache memory comprises a level two (L2) cache or a level three (L3) cache.
8. The method of any of clauses 1-7, in which the pseudo-LRU cache replacement tree comprises a binary tree.
9. The method of any of clauses 1-8, in which the status bits of nodes representing the pseudo-LRU cache replacement tree include a first value to identify a right branch to a subsequent node in a right direction and a second value to identify a left branch to a subsequent node in a left direction.
10. The method of any of clauses 1-9, in which the status bits of last nodes representing the pseudo-LRU cache replacement tree include a first value to identify a right branch to a subsequent way leaf in a right direction and a second value to identify a left branch to a subsequent way leaf in a left direction.
11. A cache memory system, comprising:
a cache memory; and
a memory controller configured to form a pseudo-least recently used (LRU) cache replacement tree having a number of way leaves greater than or equal to a number of ways of the cache memory, to identify unused ways of the pseudo-LRU cache replacement tree according to a difference between the number of way leaves of the pseudo-LRU cache replacement tree and the number of ways of the cache memory, and to update status bits of nodes representing the pseudo-LRU cache replacement tree to block access to the identified, unused ways of the cache memory.
12. The cache memory system of clause 11, in which the memory controller is further configured to update, during reading and writing of the cache memory, the status bits of nodes representing the pseudo-LRU cache replacement tree to enable detection of a pseudo-LRU way.
13. The cache memory system of any of clauses 11 or 12, in which to update status bits, the memory controller is further to block access to a way leaf representing the unused ways of the cache memory.
14. The cache memory system of any of clauses 11-13, in which the memory controller is further to lock one or more additional ways of the pseudo-LRU cache replacement tree, and to assign the one or more additional ways of the pseudo-LRU cache replacement tree to a high-priority processor.
15. The cache memory system of any of clauses 11-14, in which the pseudo-LRU cache replacement tree comprises 2^{N} way leaves, in which N is an integer greater than 1.
16. The cache memory system of any of clauses 11-15, in which the cache memory comprises a level one (L1) cache.
17. The cache memory system of any of clauses 11-15, in which the cache memory comprises a level two (L2) cache or a level three (L3) cache.
18. The cache memory system of any of clauses 11-17, in which the pseudo-LRU cache replacement tree comprises a binary tree.
19. The cache memory system of any of clauses 11-18, in which the status bits of nodes representing the pseudo-LRU cache replacement tree include a first value to identify a right branch to a subsequent node in a right direction and a second value to identify a left branch to a subsequent node in a left direction.
20. The cache memory system of any of clauses 11-19, in which the status bits of last nodes representing the pseudo-LRU cache replacement tree include a first value to identify a right branch to a subsequent way leaf in a right direction and a second value to identify a left branch to a subsequent way leaf in a left direction.

For a firmware and/or software implementation, the methodologies may be implemented with modules (e.g., procedures, functions, etc.) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for cache replacement, the method comprising:
forming a pseudo-least recently used (LRU) cache replacement tree having a number of way leaves greater than or equal to a number of ways of a cache memory;
identifying unused ways of the pseudo-LRU cache replacement tree according to a difference between the number of way leaves of the pseudo-LRU cache replacement tree and the number of ways of the cache memory; and
updating status bits of nodes representing the pseudo-LRU cache replacement tree to block access to the identified, unused ways of the cache memory.

2. The method of claim 1, further comprising updating, during reading and writing of the cache memory, the status bits of nodes representing the pseudo-LRU cache replacement tree to enable detection of a pseudo-LRU way.

3. The method of claim 1, in which updating status bits comprises blocking access to a way leaf representing the unused ways of the cache memory.

4. The method of claim 1, further comprising:
locking one or more additional ways of the pseudo-LRU cache replacement tree; and
assigning the one or more additional ways of the pseudo-LRU cache replacement tree to a high-priority processor.

5. The method of claim 1, in which the pseudo-LRU cache replacement tree comprises 2^{N} way leaves, in which N is an integer greater than 1.

6. The method of claim 1, in which the cache memory comprises a level one (L1) cache.

7. The method of claim 1, in which the cache memory comprises a level two (L2) cache or a level three (L3) cache.

8. The method of claim 1, in which the pseudo-LRU cache replacement tree comprises a binary tree.

9. The method of claim 1, in which the status bits of nodes representing the pseudo-LRU cache replacement tree include a first value to identify a right branch to a subsequent node in a right direction and a second value to identify a left branch to a subsequent node in a left direction.

10. The method of claim 1, in which the status bits of last nodes representing the pseudo-LRU cache replacement tree include a first value to identify a right branch to a subsequent way leaf in a right direction and a second value to identify a left branch to a subsequent way leaf in a left direction.

11. A cache memory system, comprising:
a cache memory; and
a memory controller configured to form a pseudo-least recently used (LRU) cache replacement tree having a number of way leaves greater than or equal to a number of ways of the cache memory, to identify unused ways of the pseudo-LRU cache replacement tree according to a difference between the number of way leaves of the pseudo-LRU cache replacement tree and the number of ways of the cache memory, and to update status bits of nodes representing the pseudo-LRU cache replacement tree to block access to the identified, unused ways of the cache memory.

12. The cache memory system of claim 11, in which the memory controller is further configured to update, during reading and writing of the cache memory, the status bits of nodes representing the pseudo-LRU cache replacement tree to enable detection of a pseudo-LRU way.

13. The cache memory system of claim 11, in which to update status bits, the memory controller is further to block access to a way leaf representing the unused ways of the cache memory.

14. The cache memory system of claim 11, in which the memory controller is further to lock one or more additional ways of the pseudo-LRU cache replacement tree, and to assign the one or more additional ways of the pseudo-LRU cache replacement tree to a high-priority processor.

15. The cache memory system of claim 11, in which the pseudo-LRU cache replacement tree comprises 2^{N} way leaves, in which N is an integer greater than 1.

16. The cache memory system of claim 11, in which the cache memory comprises a level one (L1) cache.

17. The cache memory system of claim 11, in which the cache memory comprises a level two (L2) cache or a level three (L3) cache.

18. The cache memory system of claim 11, in which the pseudo-LRU cache replacement tree comprises a binary tree.

19. The cache memory system of claim 11, in which the status bits of nodes representing the pseudo-LRU cache replacement tree include a first value to identify a right branch to a subsequent node in a right direction and a second value to identify a left branch to a subsequent node in a left direction.

20. The cache memory system of claim 11, in which the status bits of last nodes representing the pseudo-LRU cache replacement tree include a first value to identify a right branch to a subsequent way leaf in a right direction and a second value to identify a left branch to a subsequent way leaf in a left direction.
